(19) United States
(12) Patent Application Publication
(10) Pub. No.: US 2006/0030453 A1
(43) Pub. Date: Feb. 9, 2006

(54) Structure and manufacturing process for continuously-variable transmission

(75) Inventors: Taichirou Yokoyama, Kanagawa (JP); Hiroyuki Ochiai, Tokyo (JP); Fuminori Sato, Kanagawa (JP)

Correspondence Address: Pavan K. Agarwal;Foley & Lardner LLP, Washington Harbour, 3000 K Street, N.W., Suite 500, Washington, DC, 20007-5143, US

(73) Assignee: JATCO Ltd

(21) Appl. No.: 11/189,820

(22) Filed: Jul. 27, 2005

(30) Foreign Application Priority Data
Aug. 6, 2004 (JP) 2004-230752

(51) Int. Cl. B60W 10/04

(52) U.S. Cl. 477/37

(57) ABSTRACT

In a continuously-variable transmission, a powertrain is arranged to continuously vary a transmission ratio. An upper body of a control valve unit is disposed at a surface of the control valve unit confronting the powertrain. A lower body of the control valve unit is connected to the upper body. A shift control actuator is arranged to operate in accordance with an electrical signal. A shift control valve is arranged to perform a hydraulic control for the powertrain. A transmission ratio detecting section is arranged to operate mechanically in accordance with variation of the transmission ratio. A link member is disposed adjacent to the upper body and inside a plane of projection of the surface confronting the powertrain, and links the shift control actuator, the shift control valve and the transmission ratio detecting section.

### BACKGROUND OF THE INVENTION

The present invention generally relates to technique for a continuously-variable transmission having a mechanical feedback mechanism for transmission shift, and more particularly, to a layout of a shift control actuator or motor in such continuously-variable transmission.

Japanese Patent Laid-open Publication No. 2001-260678 discloses a technology for a layout of a mechanical feedback mechanism for transmission shift in a continuously-variable transmission. Specifically, Japanese Patent Laid-open Publication No. 2001-260678 discloses a structure including a link member of such mechanical feedback mechanism linking a shift control motor, a shift control valve and a pulley sensor. The link member is designed to link the pulley sensor at a powertrain side and the shift control valve in a control valve unit. Therefore, in consideration of assembling facility of these elements, the shift control motor is disposed at a lateral surface of the control valve unit, as shown in FIG. 6 of Japanese Patent Laid-open Publication No. 2001-260678.

### SUMMARY OF THE INVENTION

It is an object of the present invention to provide a structure and a manufacturing process for a continuously-variable transmission which enables a transmission unit to have a compact structure with excellent assembling facility.

According to one aspect of the present invention, a continuously-variable transmission includes: a powertrain arranged to continuously vary a transmission ratio; a control valve unit including an upper body disposed at a surface confronting the powertrain, and a lower body connected to the upper body; and a mechanical feedback mechanism including a shift control actuator arranged to operate in accordance with an electrical signal, a shift control valve arranged to perform a hydraulic control for the powertrain, a transmission ratio detecting section arranged to operate mechanically in accordance with variation of the transmission ratio, and a link member disposed adjacent to the upper body and inside a plane of projection of the surface confronting the powertrain, the link member linking the shift control actuator, the shift control valve and the transmission ratio detecting section.

According to another aspect of the present invention, for a continuously-variable transmission including: a powertrain arranged to continuously vary a transmission ratio; a control valve unit including an upper body disposed at a surface confronting the powertrain, and a lower body connected to the upper body, the control valve unit being formed with a through hole extending from a lower end opening in the lower body to an upper end opening in the upper body; and a mechanical feedback mechanism including a shift control actuator arranged to operate in accordance with an electrical signal, a shift control valve arranged to perform a hydraulic control for the powertrain, a transmission ratio detecting section arranged to operate mechanically in accordance with variation of the transmission ratio, and a link member disposed adjacent to the upper body and inside a plane of projection of the surface confronting the powertrain, the link member linking the shift control actuator, the shift control valve and the transmission ratio detecting section, the link member being arranged to abut on a circumference of the upper end of the through hole when the link member is at a position corresponding to a minimum transmission ratio of the powertrain, a manufacturing process includes: assembling a first assembly in which the transmission ratio detecting section is fitted on the powertrain assuming a position corresponding to the minimum transmission ratio; assembling a second assembly in which the shift control actuator assuming a position corresponding to the minimum transmission ratio is mounted on the upper body, and the shift control valve and the shift control actuator are linked by the link member; and fitting the second assembly to the first assembly in a state in which a positioning pin is inserted in the through hole from the lower end opening in the lower body, and concurrently, linking the link member and the transmission ratio detecting section with each other.

The other objects and features of this invention will become understood from the following description with reference to the accompanying drawings.

### BRIEF DESCRIPTION OF THE DRAWINGS

FIG. 1 is a diagrammatic view showing a structure of a continuously-variable transmission according to an embodiment of the present invention.

FIG. 2 is a partial sectional view taken along a line II-II in FIG. 1.

FIG. 3 is a plan view of a control valve unit of FIG. 1, as viewed from an upper body of the control valve unit.

FIG. 4 is an enlarged view of a link member of FIG. 1.

FIG. 5 is a sectional view taken along a line V-V in FIG. 4, showing a sensor link portion and a linking pin of FIG. 4.

FIG. 6 is a plan view showing a second assembly including the control valve unit, a shift control valve, a step motor and the link member of FIG. 1.

FIG. 7 is a bottom view showing the second assembly of FIG. 6.

FIG. 8 is a side view showing the second assembly of FIG. 6.

FIG. 9 is a series of sectional views showing the linking pin being fit into the sensor link portion of FIG. 5.

FIG. 10 is a flowchart showing a manufacturing process for the continuously-variable transmission of FIG. 1.

### DETAILED DESCRIPTION OF THE INVENTION

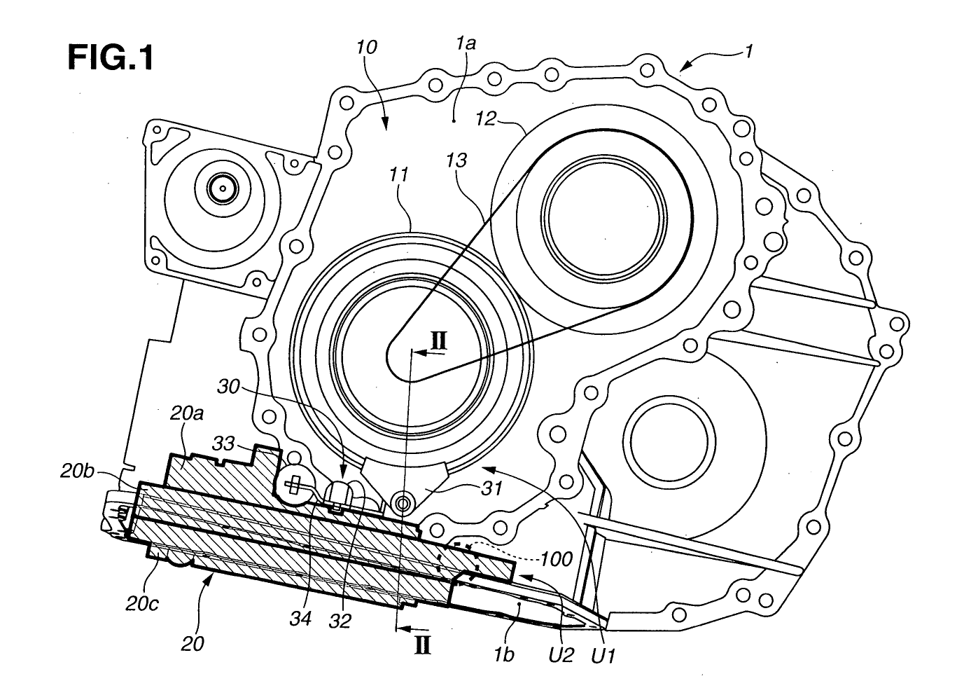

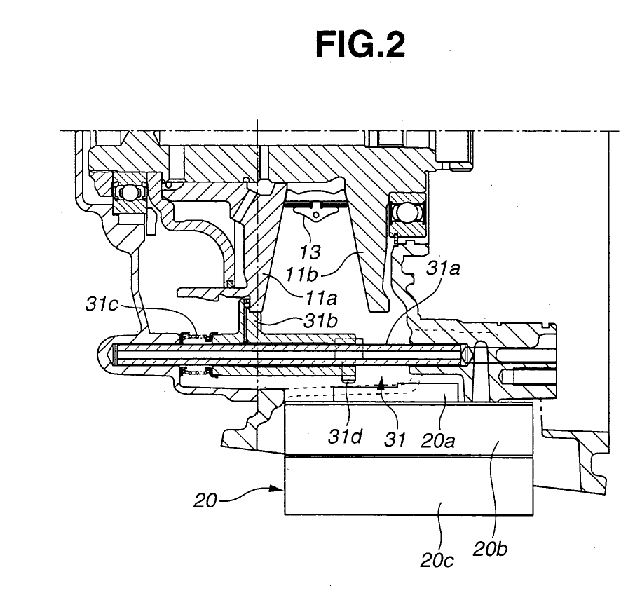

FIG. 1 is a diagrammatic view showing a structure of a continuously-variable transmission according to an embodiment of the present invention. FIG. 2 is a sectional view taken along a line II-II in FIG. 1. The continuously-variable transmission includes a transmission housing 1. The transmission housing 1 includes a powertrain housing portion la and a valve housing portion 1b. The powertrain housing portion la houses a powertrain 10. The valve housing portion 1b houses a control valve unit 20. The powertrain 10 of this example is a belt continuously-variable transmission mechanism. The powertrain 10 or belt continuously-variable transmission mechanism includes a primary pulley 11, a secondary pulley 12 and a belt 13. The primary pulley 11 includes a movable pulley portion or disk 11a and a fixed pulley portion or disk 11b, and is arranged to rotate integrally with rotation to be input from an engine in an assembled state in a vehicle. The movable pulley portion 11a and the fixed pulley portion 11b are arranged to form a pulley groove between the movable pulley portion 11a and the fixed pulley portion 11b. The secondary pulley 12 includes a movable pulley portion or disk and a fixed pulley portion or disk, and is arranged to rotate drive wheels integrally at a predetermined reduction ratio in the assembled state in the vehicle. The movable pulley portion and the fixed pulley portion of the secondary pulley 12 are arranged to form a pulley groove between the movable pulley portion and the fixed pulley portion of the secondary pulley 12. The belt 13 is wound around the pulley grooves of the primary pulley 11 and the secondary pulley 12.

Each of the primary pulley 11 and the secondary pulley 12 is formed with a cylinder chamber at the back of the movable pulley portion. Each of the cylinder chambers is arranged to vary the width of the pulley groove by hydraulic pressure. Thus, the belt continuously-variable transmission mechanism regulates an axial thrust to press the belt 13, and thereby varies an effective radius of the belt 13 wound around each of the pulley grooves. Thus, the powertrain 10 or belt continuously-variable transmission mechanism continuously varies a transmission ratio. The control valve unit 20 is provided under the powertrain 10, and is arranged to generate a hydraulic signal or electrical signal. The transmission housing 1 also includes a mechanical feedback mechanism 30 disposed between the control valve unit 20 and the powertrain 10.

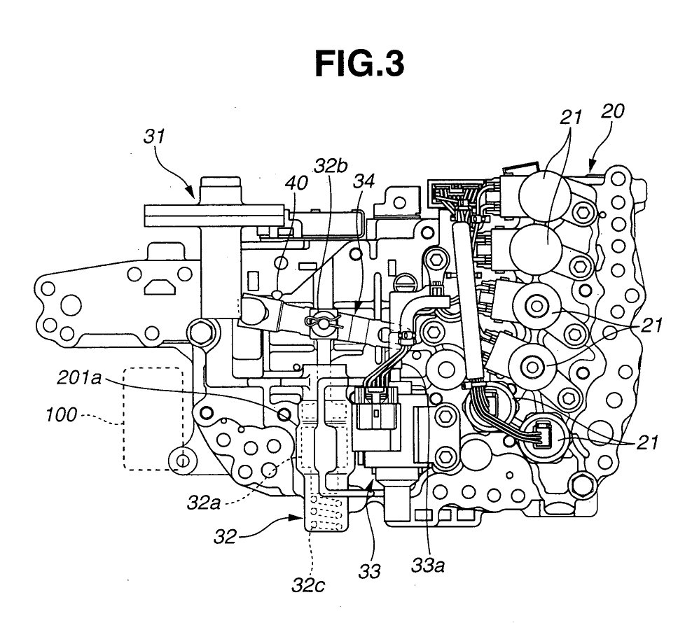

The control valve unit 20 of this example includes an upper body 20a, a middle body 20b and a lower body 20c. The upper body 20a is disposed at a powertrain side (or a surface confronting the powertrain 10) of the control valve unit 20. The lower body 20c is disposed at an oil-pan side of the control valve unit 20. The middle body 20b is disposed between the upper body 20a and the lower body 20c. Thus, in this example, the lower body 20c is connected to the upper body 20a by the middle body 20b. FIG. 3 is a plan view of the control valve unit 20, showing the upper body 20a. The continuously-variable transmission also includes electronic parts 21 and a step motor 33. The electronic parts 21 of this example are electromagnetic control valves and various sensors (such as an oil temperature sensor and a fluid pressure sensor), and are provided on an upper surface of the upper body 20a. The step motor 33 is mounted also on the upper surface of the upper body 20a. The control valve unit 20 is formed with a through hole 40 for positioning a link member 34 of the mechanical feedback mechanism 30. Besides, the control valve unit 20 is not limited to the above-described example, and may be a bipartite type including the upper body 20a and the lower body 20c, or may be a type including one body.

The mechanical feedback mechanism 30 includes a pulley sensor 31 as a transmission ratio detecting section, a shift control valve 32 arranged to perform a hydraulic control, the step motor 33 as a shift control actuator or motor, and the link member 34 mechanically linking the pulley sensor 31, the shift control valve 32 and the step motor 33. The link member 34 is disposed at the powertrain side of the control valve unit 20, or surface provided with the upper body 20a and confronting the powertrain 10. Thus, the link member 34 is disposed adjacent to the upper body 20a and inside a plane of projection of the surface of the control valve unit 20 confronting the powertrain 10.

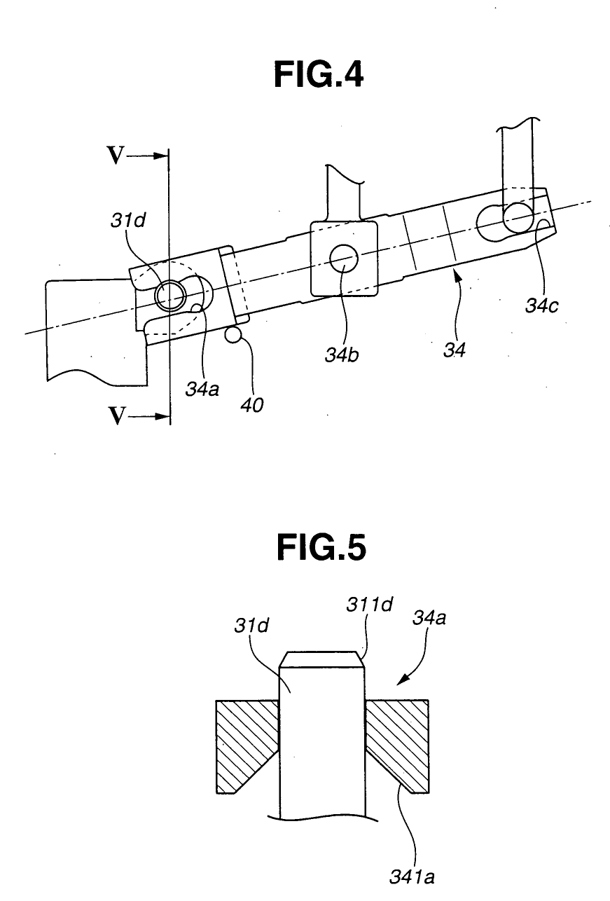

The pulley sensor 31 is disposed at a lower end of the primary pulley 11 adjacent to the upper body 20a, as shown in FIG. 2. The pulley sensor 31 includes a sensor shaft 31a, a sensor body 31b, a spring 31c and a linking pin 31d. The sensor shaft 31a is fixed to the transmission housing 1, and is formed with an axial passage extending axially in the sensor shaft 31a for supplying a lubricant or lubricating oil. The sensor body 31b is supported movably on the sensor shaft 31a, and is arranged to slide axially in contact with an outer circumferential end of the movable pulley portion 11a. Thus, the pulley sensor 31 is fitted on the powertrain 10. The spring 31c is arranged to bias the sensor body 31b toward the movable pulley portion 11a. The sensor body 31b is fitted with the linking pin 31d for linking with the link member 34, as shown in FIG. 4.

The shift control valve 32 is housed in a shift control valve housing portion 201a, as shown in FIG. 3. The shift control valve housing portion 201a is formed in a semicylindrical form projecting on the upper surface of the upper body 20a confronting the powertrain 10, and extends parallel with an axial direction of a drive shaft of the powertrain 10. The shift control valve 32 includes a shift control section 32a and a link portion 32b. The shift control section 32a is housed in the shift control valve housing portion 201a, and includes a plurality of spools. The link portion 32b projects from the shift control valve housing portion 201a toward the pulley sensor 31 in the axial direction of the drive shaft of the powertrain 10. The shift control valve housing portion 201a also houses a spring 32c arranged to bias the shift control valve 32 toward the link portion 32b.

The step motor 33 is mounted on the upper surface (confronting the powertrain 10) of the upper body 20a, and located adjacent to the shift control valve housing portion 201a. The step motor 33 includes a drive shaft 33a. The step motor 33 is arranged to operate in accordance with a shift command signal or electrical signal (representing steps) supplied from a control unit. Specifically, the drive shaft 33a is arranged to move in the axial direction of the drive shaft of the powertrain 10 by the steps represented by the shift command signal. Besides, mounting the shift control valve 32 and the step motor 33 on the same body (the upper body 20a) reduces an assembling error.

FIG. 4 is an enlarged view of the link member 34. The link member 34 includes a sensor link or receiving portion 34a, a shift control valve link portion 34b and a step motor link portion 34c. The sensor link portion 34a is fit over or receives the linking pin 31d of the pulley sensor 31 rotatably and slidably. Specifically, the sensor link portion 34a is rotatable with respect to the linking pin 31d in a plane parallel with the upper surface of the upper body 20a, and is slidable in an axial direction (indicated by a chain line in FIG. 4) of the link member 34. The shift control valve link portion 34b is linked rotatably with the link portion 32b of the shift control valve 32. The step motor link portion 34c is fit rotatably over the drive shaft 33a of the step motor 33 and slidably in the axial direction of the link member 34. FIG. 5 is a sectional view taken along a line V-V in FIG. 4, showing the sensor link portion 34a and the linking pin 31d. The sensor link portion 34a is formed with a taper surface 341a tapering outwardly around a hole receiving the linking pin 31d. The taper surface 341a has an internal sectional size becoming larger from the hole receiving the linking pin 31d toward the pulley sensor 31 (downward in FIG. 4). The linking pin 31d is formed with a taper surface 311d tapering inwardly at an end toward a direction in which the linking pin 31d is fit in or extends through the sensor link portion 34a.

When the shift command signal is supplied, and the drive shaft 33a of the step motor 33 moves in the axial direction of the drive shaft of the powertrain 10 by the steps represented by the shift command signal, the link member 34 rotates about the sensor link portion 34a as a fulcrum and thereby moves the shift control valve 32 from a neutral position (at which the shift control valve 32 is not connected to any hydraulic passage). By this movement, the shift control valve 32 changes hydraulic passages to supply hydraulic pressure to the cylinder chamber of the primary pulley 11 or the secondary pulley 12. Thus, the shift control valve 32 performs a hydraulic control for the powertrain 10. When the transmission ratio is thus started being varied in accordance with variation of the width of the pulley groove, the pulley sensor 31 starts operating mechanically by moving in the axial direction in accordance with the variation of the width of the pulley groove. This movement of the pulley sensor 31 rotates the link member 34 about the drive shaft 33a of the step motor 33, or the step motor link portion 34c, as a fulcrum, and thereby returns the shift control valve 32 to the neutral position to end the variation or shift operation of the transmission ratio. Thus, in the mechanical feedback mechanism 30, when the step motor 33 is driven by predetermined amount or steps, and consequently the transmission ratio in accordance with the amount or steps is achieved, the hydraulic control for varying the transmission ratio is automatically ended.

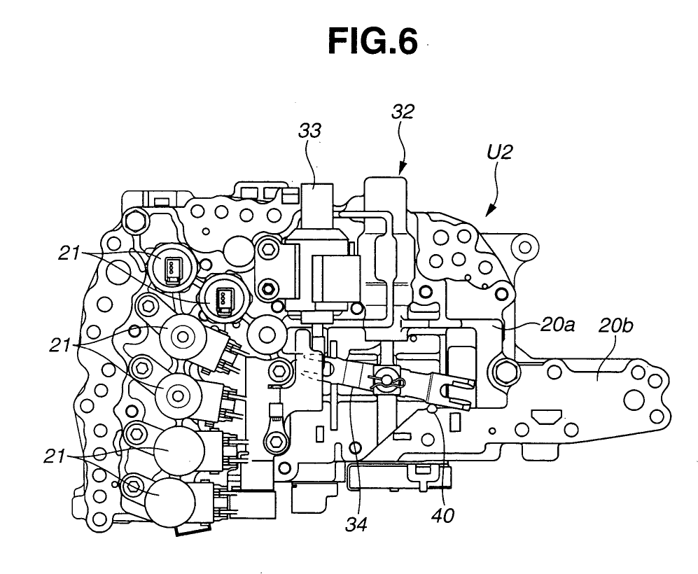

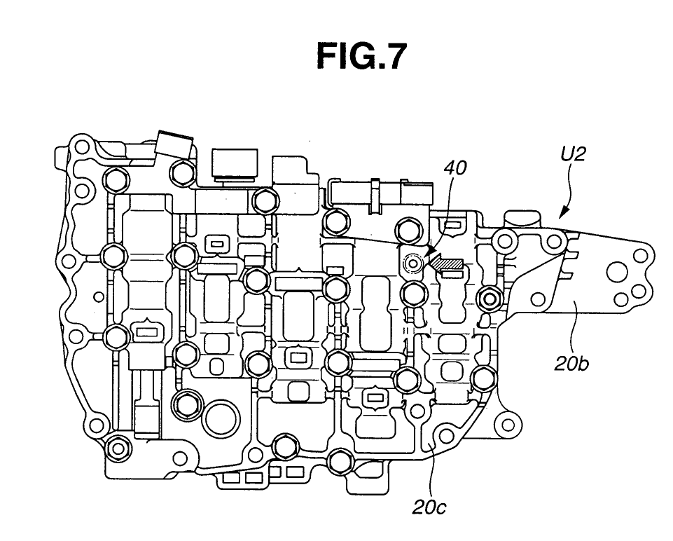

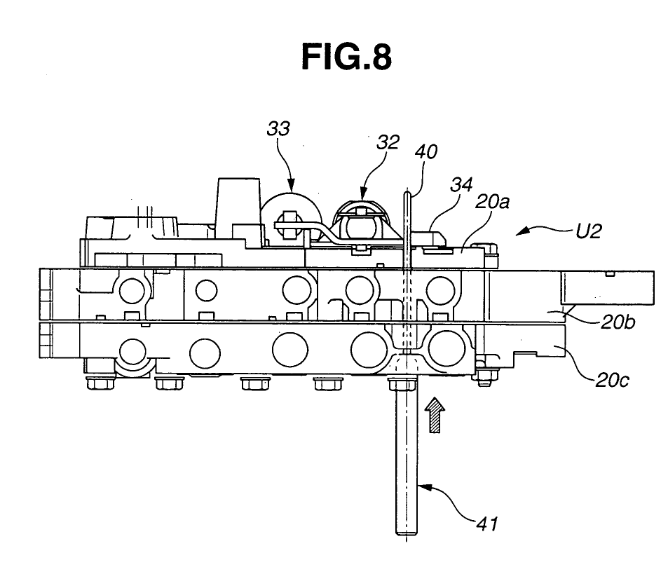

FIG. 6 is a plan view showing a second assembly U2 including the control valve unit 20, the shift control valve 32, the step motor 33 and the link member 34. FIG. 7 is a bottom view showing the second assembly U2. FIG. 8 is a side view showing the second assembly U2. The second assembly U2 is an assembly in which the shift control valve 32, the step motor 33 and the link member 34 are assembled on the control valve unit 20. The through hole 40 formed in the control valve unit 20 extends through the upper body 20a, the middle body 20b and the lower body 20c.

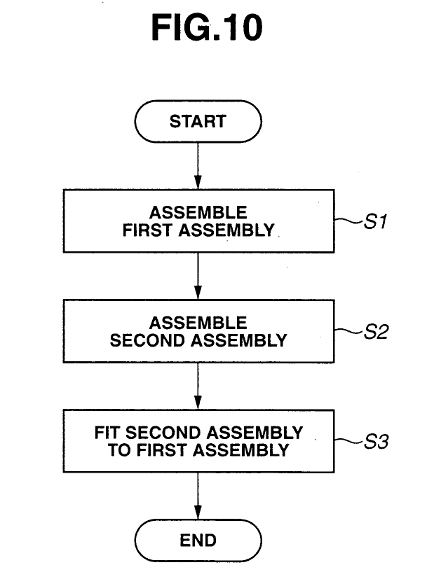

The through hole 40 extends from a lower end opening in the lower body 20c to an upper end opening in proximity of the link member 34. The upper end of the through hole 40 has a circumference on which the link member 34 is arranged to abut when the link member 34 is at a position corresponding to a minimum transmission ratio of the powertrain 10. That is, when the link member 34 is at the position corresponding to the minimum transmission ratio, the link member 34 is positioned to have a border or be in contact with the circumference at the upper end of the through hole 40. The through hole 40 is arranged to receive a positioning pin 41 to be inserted from the lower end opening in the lower body 20c. The positioning pin 41 is used in assembling the continuously-variable transmission of this embodiment, and thereafter is detached from the through hole 40. In this embodiment, the through hole 40 and/or the positioning pin 41 compose a positioning section arranged to position the link member 34. The continuously-variable transmission of this embodiment is assembled by the following steps. FIG. 10 is a flowchart showing a manufacturing process for the continuously-variable transmission of this embodiment.

(Step S1)

In a state in which the powertrain 10 assumes a position corresponding to the minimum transmission ratio (a state in which the width of the pulley groove of the primary pulley 11 is largest), the pulley sensor 31 is fitted on the powertrain 10. Thus, a first assembly U1 is assembled in the transmission housing 1.

(Step S2)

The step motor 33 assuming a position corresponding to the minimum transmission ratio is mounted on the upper body 20a of the control valve unit 20, and the shift control valve 32 and the step motor 33 are linked with each other by the link member 34. Thus, the second assembly U2 is assembled.

(Step S3)

In a state in which the positioning pin 41 is inserted in the through hole 40 from the lower end opening in the lower body 20c, the second assembly U2 is fit to the first assembly U1, and concurrently, the link member 34 and the pulley sensor 31 are linked with each other, and finally the positioning pin 41 is detached from the through hole 40. Thus, the continuously-variable transmission of this embodiment is assembled.

In the course of linking the step motor 33 and the shift control valve 32 by the link member 34 in the step S2, an initial position of the step motor 33 is easily settable by adjusting an amount of projection of the drive shaft 33a. On the other hand, since the shift control valve 32 is biased toward the link portion 32b by the spring 32c, an initial position of the shift control valve 32 is biased from a desired position (i.e., the neutral position), and is not easily settable. In the continuously-variable transmission of this embodiment, the pulley sensor 31 is fitted on the powertrain 10, and the link member 34 is mounted on the surface of the control valve unit 20 confronting the powertrain 10. Thus, the pulley sensor 31 and the link member 34 are located at positions invisible from an operator of the assembling operation. Therefore, if the initial position of the shift control valve 32 is not settled, it is difficult to link the link member 34 with the pulley sensor 31 accurately in the step S3.

By contrast, in this embodiment, the shift control valve 32 and the step motor 33 are linked by the link member 34 in the step S2, and thereafter, the positioning pin 41 is inserted into the through hole 40 in the step S3 so that the shift control valve 32 is positioned to a position corresponding to the neutral position. The thus-inserted positioning pin 41 abuts on the link member 34, and pushes back the shift control valve 32 against the spring force of the spring 32c to the desired position (i.e., the neutral position). Thus, the initial position of the shift control valve 32 is easily settled.

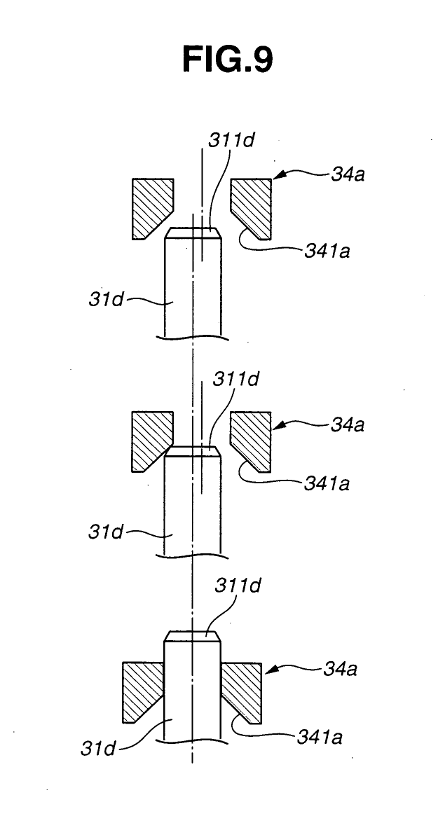

In this state, the linking pin 31d of the pulley sensor 31 set at an initial position corresponding to the minimum transmission ratio in the step S1 is fit into the sensor link portion 34a in the step S3. FIG. 9 is a series of sectional views showing the linking pin 31d being fit into the sensor link portion 34a. In the course of fitting the linking pin 31d into the sensor link portion 34a with the above-set initial position, a centerline of the sensor link portion 34a and a centerline of the linking pin 31d may be shifted from each other because of dimensional errors of the elements, or errors in assembling the elements. Even in this case, the taper surface 341a and the taper surface 311d are arranged to center the sensor link portion 34a and the linking pin 31d mutually to each other. Thus, the link member 34 and the pulley sensor 31 are linked with ease.

In the continuously-variable transmission of this embodiment including the mechanical feedback mechanism 30, the link member 34 is disposed at the powertrain side (or the surface confronting the powertrain 10) provided with the upper body 20a. Thus, the link member 34 is disposed adjacent to the upper body 20a and inside the plane of projection of the surface of the control valve unit 20 confronting the powertrain 10. If the step motor or shift control motor is disposed at an outer circumference or lateral surface of the control valve unit 20, i.e., outside the above-mentioned plane of projection, like a step motor 100 shown in FIGS. 1 and 3, it is difficult to provide the continuously-variable transmission with a compact structure. By contrast, in the continuously-variable transmission of this embodiment, the link member 34, along with the step motor 33, is disposed inside the above-mentioned plane of projection. Therefore, the continuously-variable transmission of this embodiment can have a compact structure which increases a degree of freedom in layout. Besides, in the continuously-variable transmission of this embodiment, since the shift control valve 32 and the step motor 33 are disposed on the same body, i.e., the upper body 20a, the continuously-variable transmission or the mechanical feedback mechanism 30 can be assembled with a reduced degree of assembling errors. Thereby, the continuously-variable transmission can have a precise shift start position to realize a precise shift control.

In the continuously-variable transmission of this embodiment, the electronic parts 21 necessary for the hydraulic control are provided on the upper body 20a. The electronic parts 21 of this example are electromagnetic valves and various sensors prepared for the hydraulic control. The step motor 33 and the electronic parts 21 are disposed adjacent to each other on the upper body 20a. Therefore, the continuously-variable transmission of this embodiment may utilize collective harness arrangement for the electronic parts 21 and the step motor 33, and thereby can increase the assembling facility.

In the continuously-variable transmission of this embodiment, the taper surface 311d is formed at the end of the linking pin 31d toward which the linking pin 31d is fit into the sensor link portion 34a. The taper surface 341a is formed around the hole of the sensor link portion 34a receiving the linking pin 31d. The taper surface 341a and the taper surface 311d are arranged to center the sensor link portion 34a and the linking pin 31d mutually to each other. Therefore, the link member 34 and the pulley sensor 31 are linked with ease. This centering operation is effective when at least one of the sensor link portion 34a and the linking pin 31d is formed with the taper surface 341a or 311d.

In the continuously-variable transmission of this embodiment, the through hole 40 extends from the lower end opening in the lower body 20c through the middle body 20b and the upper body 20a to the upper end opening in the proximity of the link member 34, and the positioning pin 41 is inserted in the through hole 40 from the lower end opening in the lower body 20c. The positioning pin 41 enables positioning at the positions invisible from an operator in assembling the continuously-variable transmission of this embodiment.

In the continuously-variable transmission of this embodiment, the through hole 40 is so formed as to have the circumference of the upper end in contact with the link member 34 when the link member 34 is at the position corresponding to the minimum transmission ratio. The thus-formed through hole 40 enables the shift control valve 32 to be settled to the neutral position. Therefore, the link member 34 and the pulley sensor 31 are assembled with ease.

The continuously-variable transmission of this embodiment is manufactured by the manufacturing process including the step S1, the step S2 and the step S3. The step S1 is to assemble the first assembly U1 in which the pulley sensor 31 is fitted on the powertrain 10 assuming the position corresponding to the minimum transmission ratio. The step S2 is to assemble the second assembly U2 in which the step motor 33 assuming the position corresponding to the minimum transmission ratio is mounted on the upper body 20a of the control valve unit 20, and the shift control valve 32 and the step motor 33 are linked by the link member 34. The step S3 is to fit the second assembly U2 to the first assembly U1 in the state in which the positioning pin 41 is inserted in the through hole 40 from the lower end opening in the lower body 20c of the second assembly U2, and concurrently, to link the link member 34 and the pulley sensor 31 with each other. The manufacturing process of this embodiment can provide the continuously-variable transmission having a compact structure and with excellent assembling facility even at positions invisible from an operator of the manufacturing process.

This application is based on a prior Japanese Patent Application No. 2004-230752 filed on Aug. 6, 2004. The entire contents of this Japanese Patent Application No. 2004-230752 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A continuously-variable transmission comprising:
a powertrain arranged to continuously vary a transmission ratio;
a control valve unit including an upper body disposed at a surface confronting the powertrain, and a lower body connected to the upper body; and
a mechanical feedback mechanism including a shift control actuator arranged to operate in accordance with an electrical signal, a shift control valve arranged to perform a hydraulic control for the powertrain, a transmission ratio detecting section arranged to operate mechanically in accordance with variation of the transmission ratio, and a link member disposed adjacent to the upper body and inside a plane of projection of the surface confronting the powertrain, the link member linking the shift control actuator, the shift control valve and the transmission ratio detecting section.

2. The continuously-variable transmission as claimed in claim 1, further comprising electronic parts arranged to be used for the hydraulic control, provided on the upper body, and located adjacent to the shift control actuator.

3. The continuously-variable transmission as claimed in claim 1, wherein the transmission ratio detecting section includes a linking pin for linking with the link member; the link member includes a receiving portion formed with a hole receiving the linking pin; and at least one of the linking pin and the receiving portion is formed with a taper surface at an end of the linking pin or around the hole of the receiving portion.

4. The continuously-variable transmission as claimed in claim 1, wherein the control valve unit includes a positioning section arranged to position the link member.

5. The continuously-variable transmission as claimed in claim 4, wherein the control valve unit is formed with a through hole extending from a lower end opening in the lower body to an upper end opening in proximity of the link member; and the positioning section includes a positioning pin arranged to be inserted in the through hole from the lower end opening in the lower body.

6. The continuously-variable transmission as claimed in claim 5, wherein the through hole is so formed as to have a circumference of the upper end in contact with the link member when the link member is at a position corresponding to a minimum transmission ratio of the powertrain.

7. The continuously-variable transmission as claimed in claim 1, wherein the control valve unit includes a middle body disposed between the upper body and the lower body.

8. A continuously-variable transmission comprising:
a powertrain arranged to continuously vary a transmission ratio;
a control valve unit formed with a surface confronting the powertrain, and arranged to generate an electrical signal; and
a mechanical feedback mechanism including a shift control actuator disposed on the surface of the control valve unit and arranged to operate in accordance with the electrical signal, a shift control valve disposed on the surface of the control valve unit and arranged to perform a hydraulic control for the powertrain, a transmission ratio detecting section disposed adjacent to the surface of the control valve unit, fitted on the powertrain and arranged to operate mechanically in accordance with variation of the transmission ratio, and a link member disposed on the surface of the control valve unit and linking the shift control actuator, the shift control valve and the transmission ratio detecting section.

9. A manufacturing process for a continuously-variable transmission including:
a powertrain arranged to continuously vary a transmission ratio;
a control valve unit including an upper body disposed at a surface confronting the powertrain, and a lower body connected to the upper body, the control valve unit being formed with a through hole extending from a lower end opening in the lower body to an upper end opening in the upper body; and
a mechanical feedback mechanism including a shift control actuator arranged to operate in accordance with an electrical signal, a shift control valve arranged to perform a hydraulic control for the powertrain, a transmission ratio detecting section arranged to operate mechanically in accordance with variation of the transmission ratio, and a link member disposed adjacent to the upper body and inside a plane of projection of the surface confronting the powertrain, the link member linking the shift control actuator, the shift control valve and the transmission ratio detecting section, the link member being arranged to abut on a circumference of the upper end of the through hole when the link member is at a position corresponding to a minimum transmission ratio of the powertrain, the manufacturing process comprising:
assembling a first assembly in which the transmission ratio detecting section is fitted on the powertrain assuming a position corresponding to the minimum transmission ratio;
assembling a second assembly in which the shift control actuator assuming a position corresponding to the minimum transmission ratio is mounted on the upper body, and the shift control valve and the shift control actuator are linked by the link member; and
fitting the second assembly to the first assembly in a state in which a positioning pin is inserted in the through hole from the lower end opening in the lower body, and concurrently, linking the link member and the transmission ratio detecting section with each other.
